(19) United States
(12) Patent Application Publication
(10) Pub. No.: US 2007/0045302 A1
(43) Pub. Date: Mar. 1, 2007

(54) Microwave overheating prevention container

(75) Inventors: Takafumi Fujii, Niigata-ken (JP); Yu Kobayashi, Niigata-ken (JP)

Correspondence Address: SACCO & ASSOCIATES, PA, P.O. BOX 30999, PALM BEACH GARDENS, FL, 33420-0999, US

(73) Assignees: Thermos Limited Liability Company, Rolling Meadows, IL (US); Thermos K.K., Tsubame-shi (JP)

(21) Appl. No.: 11/507,415

(22) Filed: Aug. 21, 2006

(30) Foreign Application Priority Data
Aug. 30, 2005 (JP) JP 2005-248855

(51) Int. Cl. H05B 6/80

(52) U.S. Cl. 219/730

(57) ABSTRACT

A microwave overheating prevention container has at least an external surface in internal and external surfaces of a metallic container coated with a nonmetallic material which is a synthetic resin material. The metallic container comprises an internal container and an external container where end faces are joined together with a space provided between the internal and external containers. The space between the internal container and the external container is vacuumed.

### CROSS REFERENCE TO RELATED APPLICATIONS

This application claims the benefit of priority to Japanese patent application serial number 2005-248855, filed on Aug. 30, 2005, which is herein incorporated by reference.

### BACKGROUND OF THE INVENTION

1. Field of the Invention

The present invention relates to a microwave overheating prevention container which can be used under microwave irradiation from a microwave oven or the like, and prevent overheating.

2. Description of the Related Art

Microwave ovens are cooking devices which irradiate a microwave onto a food in a container to heat the food. Materials for the container are limited. That is, if a metallic container is used, microwave irradiation may generate sparks between the metallic container and the wall of the microwave oven, so that the container or the microwave oven may be damaged. In this respect, containers made of ceramics or synthetic resins, not a metal, are used as containers for heating a food therein in a microwave oven.

However, metallic containers are generally and widely used as food containers because of a high durability and a superior texture. Accordingly, there is a strong demand to heat a food put in a metallic container in a microwave oven. To fulfill the demand, there are proposed various metallic containers which generates no sparks even if heated with a microwave oven (for example, see Patent Literatures 1 to 4).

Each of the metallic containers disclosed in those Patent Literatures is typically held away from the turn table of a microwave oven at a predetermined distance to suppress generation of sparks.

Patent Literature 1: Japanese Registered Utility Model Publication No. 3086451

Patent Literature 2: Japanese Patent Publication No. H7-84226

Patent Literature 3: Japanese Utility Model Publication No. H6-1088

Patent Literature 4: Unexamined Japanese Patent Publication No. 2005-53535

In a case where a metallic container like a lunch jar is directly placed in a microwave-heated cooking device like a microwave oven and heated, heating the container for five minutes or so makes the container too hot to hold with bare hands. However, an object in the container subject to heating is not heated as much as the container, so that it is necessary to continue heating without stopping the microwave oven. This raises a problem such that a synthetic resin attached to the lower portion of the turn table for rotating the turn table reaches a melting temperature, and is melted.

In a case where a metallic container like a lunch box is heated by a microwave oven, there is a similar problem because the temperature of the lunch box itself is likely to rise rather than that of an object to be heated in the container. However, because the object to be heated in the container becomes hot not a little, a user hardly recognizes overheating of the metallic container until the turn table of a synthetic resin of the microwave oven is damaged.

Further, a container made of a resin employs a double-wall structure of an internal container and an external container with a space between the double walls functioning as a thermal insulation space. When a heat insulative container having a metal foil disposed in the space is irradiated with a microwave and heated, therefore, the end portion of the metal foil is heated most, causing the container to be melted and broken.

The present invention is made in view of the foregoing circumstances, and it is an object of the invention to provide a microwave overheating prevention container which prevents the surface of the metallic container from being excessively heated and can be handled safely even through a food to be heated is put in the metallic container and heated by a microwave oven.

Another object of the invention is to provide a microwave overheating prevention container which generates no sparks between a metallic container and a turn table or the like and does not damage a microwave oven even though a food to be heated is put in the metallic container and heated by the microwave oven.

A further object of the invention is to provide a microwave overheating prevention container which can easily heat a food to be heated, and keep the food hot for a long time.

### SUMMARY OF THE INVENTION

A microwave overheating prevention container according to the invention has at least an external surface in internal and external surfaces of a metallic container coated with a nonmetallic material.

The nonmetallic material is a synthetic resin material.

The metallic container comprises an internal container and an external container, and end faces of the internal container and the external container are joined together with a space provided therebetween.

The space between the internal container and the external container is vacuumed.

A material for the metallic container is a stainless steel.

The microwave overheating prevention container may have a heat insulative lid.

According to the microwave overheating prevention container, because the external surface of the metallic container is coated with a nonmetal material, even if a content like a food to be heated is put in the container and heated for 10 minutes or so, the temperature of the container does not rise above the temperature at which a user can hold the container by hands. Therefore, the metallic container after the food to be heated is heated can be handled safely. Because it is possible to prevent occurrence of sparks, a microwave oven is not damaged.

### BRIEF DESCRIPTION OF THE DRAWINGS

FIG. 1 is a cross-sectional view illustrating a microwave overheating prevention container according to a first embodiment of the invention;

FIG. 2 is a cross-sectional view illustrating a microwave overheating prevention container according to a second embodiment of the invention;

FIG. 3 is a cross-sectional view illustrating a microwave overheating prevention container according to a third embodiment of the invention; and

FIG. 4 is a characteristic diagram illustrating measured values of temperatures of the metal surface of a metallic container.

### DETAILED DESCRIPTION OF THE PREFERRED EMBODIMENTS

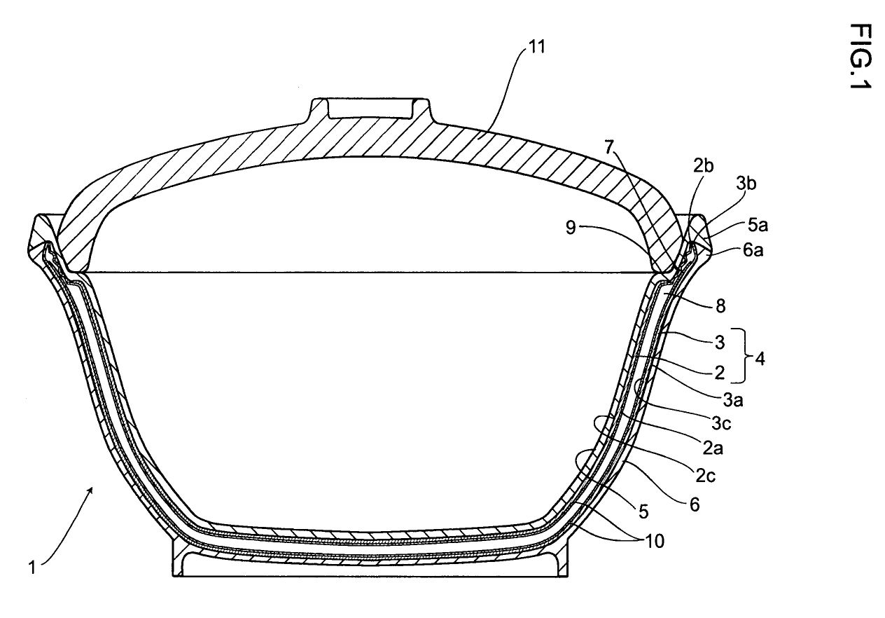

An embodiment of the invention will be explained with reference to the accompanying drawings. FIG. 1 is a cross-sectional view illustrating a microwave overheating prevention container 1 according to the first embodiment of the invention. The microwave overheating prevention container 1 of the embodiment is applied to a food container which is a “bowl”. The microwave overheating prevention container 1 comprises a metallic container 4 with a double-wall structure having an internal container 2 and an external container 3. An internal surface 2a of the internal container 2 and an external surface 3a of the external container 3 are respectively coated with an internal coating member 5 and an external coating member 6, both of synthetic resin materials. The metallic container 4 is formed in such a way that an opening portion 2b of the internal container 2 and an opening portion 3b of the external container 3 are joined together airtightly and integrally.

The internal container 2 made of a metal and the external container 3 made of a metal are separately manufactured by pressing or the like. In the manufacturing, an evacuation hole (not shown) is formed in the external container 3. The internal container 2 is provided with a multi-bent step portion 7 to make a heat transfer length of the opening portion 2b longer as will be discussed later.

The opening end 2b of the metallic internal container 2 and the opening end 3b of the metallic external container 3 are integrally joined together by welding or the like. Accordingly, an end portion which is most likely to cause sparks is eliminated, and an anti-spark property is enhanced. The width of a space 8 (heat insulative layer 8) formed between the metallic internal container 2 and the metallic external container 3, i.e., a clearance between the metallic internal container 2 and the metallic external container 3 is set to 4 mm or so. This makes it possible to suppress the thickness of the heat insulative layer 8 to the minimum while assuring a sufficient heat retention performance, so that the overall volume efficiency of the container is improved.

The multi-bent step portion 7 along the vertical direction is formed at a portion of the opening end 2b of the internal container 2 above a step portion which has an expanded diameter to close the opening portion 2b and is dented toward the insulative layer 8. Accordingly, the heat transfer length at the opening portion 2b of the internal container 2 is made longer, thus reducing heat transfer loss, and the heat retention performance of the heat insulative container is improved. The structure of the step portion 7 serves to make the moving distance of heat longer, and absorb external force applied in welding the opening portions 2b, 3b for integration thereof.

A preferable material for the metallic container 4 is an austenitic stainless steel plate (SUS 304) having a good anti-corrosion property. The thicker the thickness of the stainless steel plate is, the more superior the heat insulation performance and the cost performance are. If the thickness of the plate is too thin, however, the container lacks the necessary strength and rigidity. Accordingly, the appropriate thickness is 0.2 to 0.6 mm, and the preferable thickness is 0.3 mm or so. If the thickness is less than or equal to 0.1 mm or the thickness of an aluminum foil, for example, the influence of overheating arises.

The space 8 formed between the metallic internal container 2 and the metallic external container 3 is sealed and vacuumed after evacuated to a predetermined vacuum degree. In consideration of the heat insulation performance and the manufacturing cost, the predetermined vacuum degree is set to less than or equal to 1.332×10-1 Pa. Vacuum evacuation and vacuum sealing are carried out by, for example, putting the integrally joined metallic container 4 with the double-wall structure in a vacuum heating furnace, performing a vacuum heating process to set the space 8 to the predetermined vacuum degree, and then sealing the evacuation hole provided in the external container 3. The evacuation and the vacuum sealing can be done by a general vacuum space formation method of, for example, coupling an evacuation device to the evacuation hole provided in the external container 3, and sealing the evacuation hole when the vacuum degree of the space 8 reaches the predetermined vacuum degree. Of surfaces 2c, 3c of the metallic internal container 2 and the metallic container 3 which lie closer to the space 8 formed therebetween, at least the surface 2c on the internal container 2 side is provided with a foil of a metal like aluminum, and a radiation prevention layer 10 made of a metallic layer, so that the heat insulation performance of the internal container 2 can be further enhanced. In the embodiment illustrated in FIG. 1, the radiation prevention layers 10 are provided on both sides of the space 8.

It is preferable that at least an external surface 3a in an internal surface 2a and the external surface 3a of the metallic container 4 should be coated with the coating member 6 of a synthetic resin material excellent in heat resistance, humidity resistance (anti-moisture permeability), and mechanical strength. The thickness of the synthetic resin is generally set between 0.5 mm to 3.0 mm because of the formability thereof, but is appropriately set between 1.0 mm to 2.5 mm from the standpoints of absorption of a microwave and prevention of overheating.

The synthetic resin material preferably has a moisture permeability complying with “JIS Z 0280” and less than or equal to 50 g/m2/24 hr under conditions of a temperature of 40° C. and a relative humidity of 90%, and a bending modulus complying with “ASTM M D 790”, and greater than or equal to 10000 kg/cm2, and/or an Izod impact strength (with notches) of greater than or equal to 20 J/m. Possible synthetic resin materials having such properties are polypropylene, ABS, polycarbonate, and the like.

Because those synthetic resin materials have a low adsorptive property and a superior chemical resistance, there is an advantage such that a problem of odor absorption can be significantly reduced if those materials are used for the container for cooking. Coating the external surface 3a of the metallic container 4 with the synthetic resin has an advantage of facilitating patterning on a coated surface by printing or the like. In the embodiment illustrated in FIG. 1, the internal and external surfaces 2a, 3a of the metallic container 4 are respectively coated with the internal and external coating members 5, 6, both made of synthetic resins.

The synthetic-resin-made internal and external coating members 5, 6 which coat the metallic container 4 are manufactured separately by injection molding, and the internal and external coating members 5, 6 are integrated with each other by joining respective end portions 5a, 6a of the coating members 5, 6 together after the metal member 4 is coated therewith. Possible integration methods are welding and screwing. Another embodiment of the invention allows application of a so-called insert molding of disposing the metallic container 4 manufactured beforehand at a predetermined position of a synthetic resin molding having a desired shape, pouring a synthetic resin on at least one of the internal and external surfaces 2a, 3a of the metallic container 4, and integrating the metallic container 4 and the synthetic resin in such a way that the synthetic resin adheres tightly to the metallic container 4.

A lid 11 which closes the opening of the metallic container 4 is not an essential member of the invention. However, if the lid 11 having a heat insulation property is used together with the metallic container 4 with the double-wall structure, it is possible to prevent heat from being dissipated as vapors from a food to be heated when the food is heated in a microwave oven. This brings about advantages such that wasteful energy is suppressed, and the heating time is shortened in comparison with a case where heating is carried out with the metallic container 4 alone, without the lid 11. Further, even if the microwave overheating prevention container 1 is left in the microwave oven after heating is completed, a cooked food is kept warm in the microwave overheating prevention container 1 and the lid 11, so that the cooked food is kept warm for a long time.

To provide the lid 11 with a heat insulation property, the lid 11 can employ double-wall structure made of a resin, but it is practical to use the lid 11 formed of an urethane foam material as the lightweight and low-cost lid 11 having a certain level of heat insulation property.

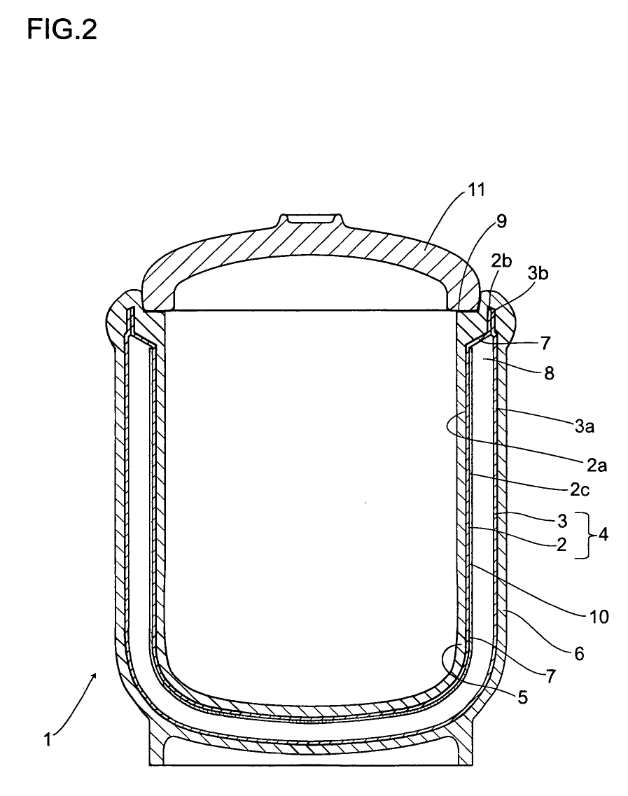

FIG. 2 is a cross-sectional view illustrating a microwave overheating prevention container 1 according to the second embodiment of the invention. The microwave overheating prevention container 1 is applied to a food container which is a “tea cup”. The “tea cup” is used for cooking a steamed egg hotchpotch. The basic structure of the microwave overheating prevention container 1 is the same as that of the first embodiment. A difference from the first embodiment is that a metal foil as the radiation prevention layer 10 is not provided on the external container 3 side in the space 8 as a vacuum heat insulative room.

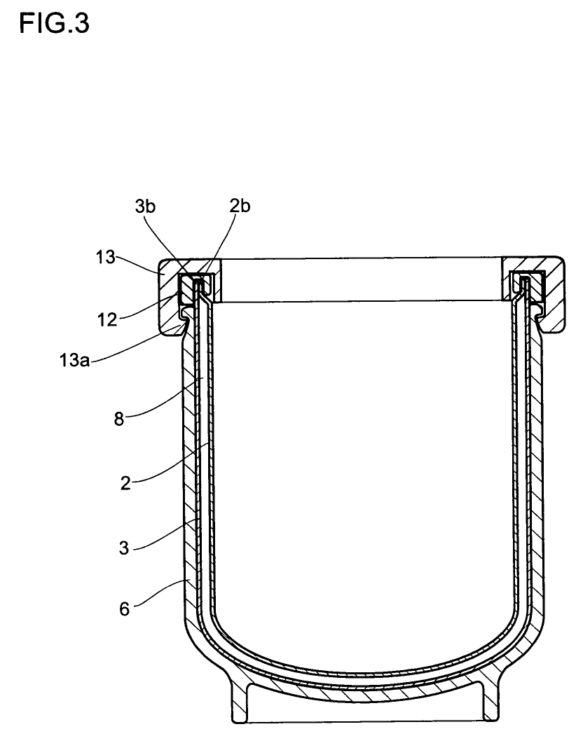

FIG. 3 is a cross-sectional view illustrating a microwave overheating prevention container according to the third embodiment of the invention. Like the second embodiment, the invention is applied to a food container which is a “tea cup”, but as illustrated in this cross-sectional view, a lid is not placed on the opening of the tea cup. The external surface of the external container 3 in the metallic internal and external containers 2, 3 is coated with the external coating member 6. The space 8 is provided between the internal container 2 and the external container 3, and an end face (opening portion) 2b of the internal container 2 and an end face (opening portion) 3b of the external container 3 are joined together. A cover 13 made of a resin is mounted on that portion where the end faces 2b, 3b of the internal and external containers 2, 3 are joined together through a packing 12 for ensuring a sealing property. The cover 13 is for avoiding that the end faces 2b, 3b of the internal and external containers 2, 3 are exposed at the opening of the tea cup, and is formed in a ring-like shape with a cross section of an inverted U shape. The cover 13 is engaged with the external coating member 6 by a protrusion 13a provided at an external end of the cover 13 formed in the inverted U shape. According to the microwave overheating prevention container 1 of the embodiment, the metallic internal and external containers 2, 3 are not directly held by a user's hands, and can be handled safely after heating.

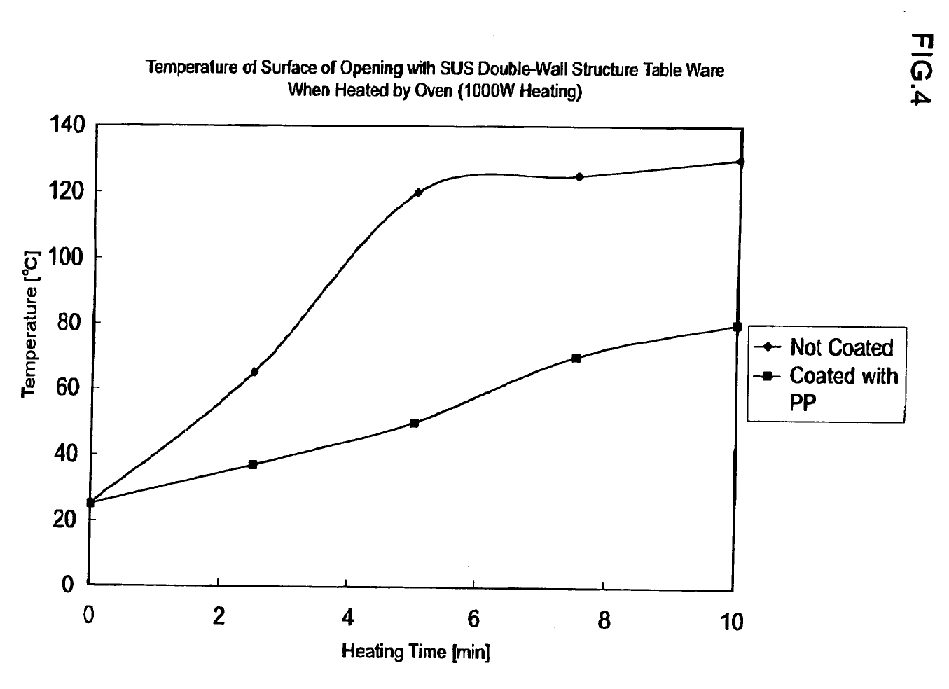

FIG. 4 is a diagram illustrating measured values of metal surface temperatures comparing a case where the surface of a metallic container was coated with a synthetic resin material of polypropylene and a case where the surface of the metallic container was not coated. As will be apparent from the diagram, coating the surface of the metallic container with the synthetic resin materials suppresses the temperatures of the metal surface low in comparison with the non-coating case.

The invention has been explained based on the foregoing embodiments, but can be modified in various forms. For example, in the foregoing embodiments, the invention is applied to the metallic container 4 employing a double-wall structure, but is not limited to a container with a double-wall structure which has a heat insulation property. That is, it is needles to say that the invention can be applied to a metallic container with a single piece plate structure.

In the foregoing embodiment, the lid 11 of the metallic container is a simple lid which is made of an urethane foam, but may be a lid made of a resin with a double-wall structure. It is important that the opening of the container is made as small as possible from the standpoint of heat retention, but it is required that the diameter of the opening is greater than or equal to 12 mm because microwave heating is necessary.

What is claimed is:

1. A microwave overheating prevention container having at least an external surface in internal and external surfaces of a metallic container coated with a nonmetallic material.

2. The microwave overheating prevention container according to claim 1, wherein said nonmetallic material is a synthetic resin material.

3. The microwave overheating prevention container according to claim 1, wherein said metal container comprises an internal container and an external container, and end faces of said internal container and said external container are joined together with a space provided therebetween.

4. The microwave overheating prevention container according to claim 2, wherein said metal container comprises an internal container and an external container, and end faces of said internal container and said external container are joined together with a space provided therebetween.

5. The microwave overheating prevention container according to claim 3, wherein said space between said internal container and said external container is vacuumed.

6. The microwave overheating prevention container according to claim 4, wherein said space between said internal container and said external container vacuumed.

7. The microwave overheating prevention container according to claim 1, wherein a material for said metal container is stainless steel.

8. The microwave overheating prevention container according to claim 2, wherein a material for said metal container is stainless steel.

9. The microwave overheating prevention container according to claim 3, wherein a material for said metal container is stainless steel.

10. The microwave overheating prevention container according to claim 4, wherein a material for said metal container is stainless steel.

11. The microwave overheating prevention container according to claim 5, wherein a material for said metal container is stainless steel.

12. The microwave overheating prevention container according to claim 6, wherein a material for said metal container is stainless steel.

13. The microwave overheating prevention container according to claim 1 having a heat insulative lid.

14. The microwave overheating prevention container according to claim 2 having a heat insulative lid.

15. The microwave overheating prevention container according to claim 3 having a heat insulative lid.

16. The microwave overheating prevention container according to claim 4 having a heat insulative lid.

17. The microwave overheating prevention container according to claim 5 having a heat insulative lid.

18. The microwave overheating prevention container according to claim 6 having a heat insulative lid.
